(19) United States
(12) Patent Application Publication
(10) Pub. No.: US 2011/0016060 A1
(43) Pub. Date: Jan. 20, 2011

(54) METHOD AND SYSTEM FOR EVALUATING MODULATED VOLUME INFORMATION FOR A TRADABLE ELEMENT

(76) Inventor: Vladimir A. Korzinin, Surrey (CA)

Correspondence Address: Valuetech c/o John R. Flanagan, 601 Country Club Road, Apt. 1085, P.O. Box 2629, Eugene, OR, 97402, US

(21) Appl. No.: 12/890,589

(22) Filed: Sep. 24, 2010

Related U.S. Application Data
(63) Continuation-in-part of application No. 11/184,878, filed on Jul. 20, 2005, now Pat. No. 7,813,984.

(51) Int. Cl. G06Q 40/00

(52) U.S. Cl. 705/36 R

(57) ABSTRACT

A method and system for evaluating modulated volume information for a tradable element, such as a security or commodity, determines modulated volume information that compensates for normal fluctuations in volume occurring during the course of a trading period, thereby enabling convenient visualization of abnormal volume activity. Once determined, the evaluating method and system can display and/or store the modulated volume information or output the modulated volume information to other algorithms that may filter it based on a threshold, a price moving average or a comparison of the current price with a price moving average, for example to generate further displays including trading indicators or signals.

This application is a continuation-in-part of and claims the benefit of U.S. patent application Ser. No. 11/184,878, filed Jul. 20, 2005.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This application relates to a method and system for evaluating modulated volume information for a tradable element, such as a security or commodity.

### BACKGROUND

Advances in technology have increased the number of avenues for traders to invest in stocks, bonds, futures, convertible securities, commodities and other tradable elements in markets worldwide. This trend has also increased the need for delivery of timely trading data to investors. It is now commonplace for traders to access market analysis tools electronically via e-mail or website access.

Many technical analysis tools focus on price as the key market indicator. For example, tools based on moving averages of securities prices are well-known. However, an equally important factor that is often overlooked is market volume. Volume represents the actual supply and demand that moves prices higher and lower. Volume is therefore an important indicator that can offer key insights into the strength of a market trend.

Volume analytics can be employed, for example, to forecast reversals in stock exchange indices. In the case of a securities index, sudden surges in trading volume indicate bursts of significant buying or selling activity. There are many complex reasons why this might occur. If the index price trend is rising when a volume surge occurs, this is typically referred to as a “resistive” volume spike. On the other hand, if the index price trend is declining when the volume surge occurs, this is referred to as a “supportive” volume spike. As a general rule, resistive volume spikes will force a downward move in an index whereas supportive volume spikes generate upward index momentum.

However, it is often very difficult using conventional market analysis tools to identify volume fluctuations which are truly significant. Many currently available systems are limited to delivering daily delayed data and fail to take into account volume fluctuations which occur at intervals within the trading period. In many cases volume activity follows predictable patterns throughout the trading day. High volume levels are usually prevalent immediately after the markets open due to trades left over from the previous day and a large amount of at-market-open orders. Lower values occur around noon when traders typically take their lunch break, thereby lowering the number of active participants in the market. Increased volume levels once again occur toward the end of the trading day when many short-term traders and institutional investors close their positions. Thus the time of the day often has a direct influence on volume activity. It is therefore often difficult to differentiate abnormal, analytically significant volume fluctuations from historically normal intra-day variations.

Some systems are known in the prior art for attempting to normalize volume data so that at least some cyclic intra-day fluctuations are discounted and abnormal volume variations can be more readily visualized. For example, as described further below, some systems rely on standard trade distribution profiles which are intended to approximate typical market activity patterns. There are several significant drawbacks to this approach. First, not all markets for tradable elements will exhibit the standard profile. Second, even in the case of tradable elements which ordinarily do track the standard profile, important deviations may occur at some trading intervals due to various extraneous factors. In such cases, the normalized data may obscure important volume spikes or suggest market abnormalities where none exist. Accordingly, in many cases conventional systems yield inaccurate results and cannot be applied generally to all market scenarios.

The need has therefore arisen for improved methods and systems for modulating volume information which rely on actual historical volume data for the tradable element in question rather than imprecise trade distribution profiles.

Once the modulated volume information has been calculated there may be a need to analyze it according to the wishes of the user. This may involve further calculations as well as the display of further graphical representations of the analyzed information, so that it can be more rapidly understood at a glance.

At the present, commonly known basic filtration methods are often used to manipulate volume. In a typical technical analysis the volume is defined as bullish or bearish in relation to the price bar direction. If, for the current bar or time period, the close price is above the close price for the previous bar, then the volume associated with the current bar is considered to be bullish. Bullish volume is otherwise known as a positive volume or buying volume. The volume is considered to be bearish or negative, or a selling volume if the close price of the current bar is below the close price of the previous bar. This method is used to define advance and decline volume indicators. The same method is used in other volume based technical indicators, such as accumulation/distribution indicators, the Chaikin Money Flow index, etc. The same method is used in defining and building selling and buying volume indicators.

While the method described above is considered a good tool to filter volume as either positive or negative volume, the trouble of using it is that the actual price on the market has spikes and short-lived corrections that can either be below or above the trend line. As an example, a stock price can move upward for five consecutive periods, then down for one period and then up again for the following five periods. The commonly known methods of positive and negative volume filtering would result in an indication that the volume associated with the intervening downward price movement is negative, despite the fact that the general price direction over the overall period of time is upward.

### SUMMARY OF INVENTION

The present invention is directed to a method and system which incorporates filtering of modulated volume information such that users, such as investors, may select to analyse or view only the volumes which are associated with strong upward and/or downward price or value trends and the like.

In accordance with one aspect of the invention, a processor-implemented method for evaluating modulated volume information for a tradable element comprises: determining by a data processor modulated volume information for a plurality of time intervals in a selected trading period so as to provide abnormal volume variation information for the tradable element during the trading period; filtering by the data processor the modulated volume information to remove a first portion thereof and leave a filtered second portion thereof in respective relationships to a criterion comprised by a filter level; and displaying on a data display the filtered second portion of the modulated volume information.

In accordance with another aspect of the invention, a processor-implemented method for evaluating modulated volume information for a tradable element, comprises: determining by a data processor modulated volume information for a plurality of time intervals in a selected trading period providing abnormal volume variation information for the tradable element during the selected trading period; calculating by the data processor a price moving average for the selected time intervals; and filtering by the data processor the modulated volume information to remove a first portion thereof and leave a filtered second portion thereof in respective relationships to the price moving average.

In accordance with another aspect of the invention, a system for implementing the above-described method comprises: a data processor; a data display in communication with the data processor; and a computer readable medium carrying instructions for processing by the data processor; the system being configured to: determine by the data processor modulated volume information for a plurality of time intervals in a trading period so as to provide abnormal volume variation information for the tradable element during the trading period; filter by the data processor the modulated volume information to remove a first portion thereof and leave a filtered second portion thereof in respective relationships to a criterion comprised by a filter level; and display on the data display the filtered second portion of the modulated volume information.

### BRIEF DESCRIPTION OF DRAWINGS

In drawings which illustrate embodiments of the invention, but which should not be construed as restricting the spirit or scope of the invention in any way,

FIG. 1 is a graph showing averaged (one day) unmodulated volume data for a stock market index in conjunction with price data for a six month period.

FIG. 2 is a graph showing a normal trade (volume) distribution for a market index at intervals during a one day trading period. The volume information is shown in conjunction with price information for the same period.

FIGS. 3A-3C taken together show a table numerically listing unmodulated volume data for a market index (S&P 500) at one minute intervals during a one day trading period (Jul. 7, 2005).

FIG. 4 is graph showing averaged volume data for a stock market index in conjunction with price data for a fifteen day period. Each bar of the volume plot of the graph represents 15 minutes of volume information.

FIG. 5 is a graph showing the averaged volume data of FIG. 4 modulated in accordance with the invention to remove the effect of cyclic intra-day variation in the distribution of trades.

FIG. 6 is a flowchart schematically showing embodiments of the invention for determining modulated volume information from an unmodulated data stream.

FIGS. 7A-7E taken together show a table numerically listing intra-day volume data for a market index (S&P 500) averaged for multiple trading days 2005.

FIG. 8 is a graph showing a moving average of modulated volume information for a market index plotted in conjunction with price. Each bar of the volume plot of the graph represents 5 minutes of modulated volume information.

FIG. 9 is a graph showing the relationship between modulated volume spikes and a subsequent reversal in a market index price trend.

FIG. 10 is a flowchart showing a process of filtering and displaying modulated volume.

FIG. 11 is a graph showing price values of a stock market index and modulated volume for an eighteen day period, with a filter line.

FIG. 12 is the graph of FIG. 11 showing only the filtered, modulated volume.

FIG. 13 is a graph showing price values of a tradable element and modulated volume for an eighteen day period, with a price moving average of the values of the tradable element.

FIG. 14 is a flowchart showing a process of filtering modulated volume with respect to a price moving average and displaying the result.

FIG. 15 is the graph of FIG. 13 with the modulated volume removed for periods where the value of the index is below the price moving average.

FIG. 16 is the graph of FIG. 13 with the modulated volume removed for periods where the value of the index is above the price moving average.

FIG. 17 is the graph of FIG. 13 with the modulated volume removed for periods where the price moving average changes minimally or not at all.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This application relates to a method and system for evaluating modulated volume information for a tradable element. As used herein the term “tradable element” means any element which may be traded during the course of a trading period. For example, a tradable element may include a security or a commodity, or a group of securities or commodities, which are bought and sold in a market during the trading period. As used herein a “security” may include investment vehicles such as shares, stocks, bonds, convertible securities, options, derivatives, futures and currencies. A security (and hence a tradable element) may also comprise a basket of securities including an index, sub-index or an entire exchange of securities, such as the S&P 500, the NASDAQ 100, the Russell 3000 and the like. A security may also relate to other market items which fluctuate in number at intervals during the course of a trading period, such as the number of contracts, ticks or open interest. A “commodity” may include any element of trade which can be bought or sold in a market, such as food items, oil, chemicals and other tangible or intangible items.

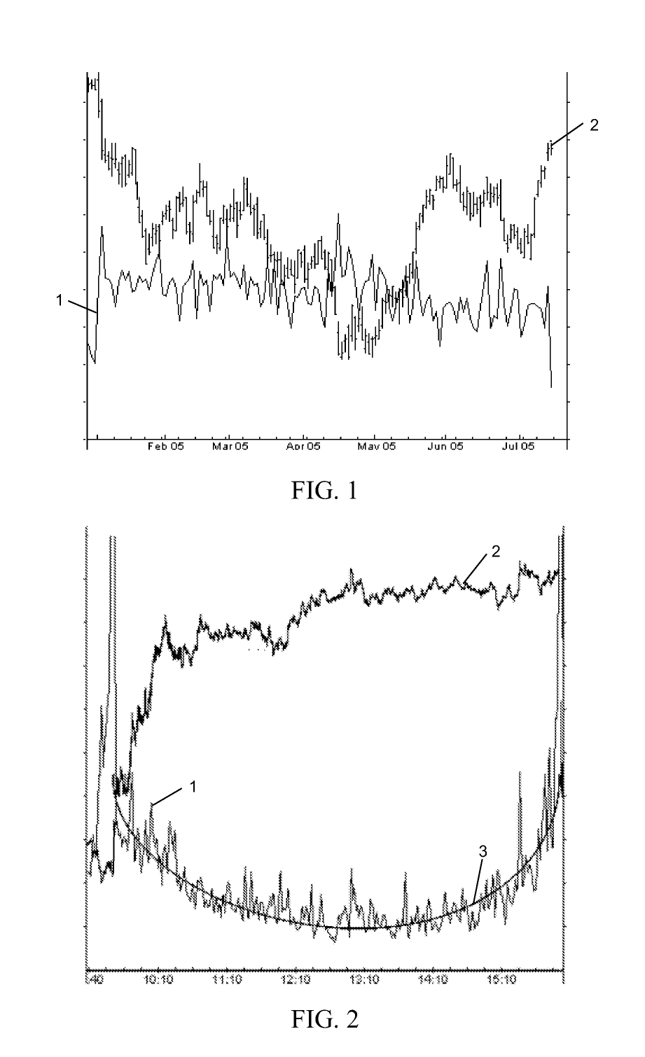

As used herein the term “volume” refers to a measurable quantity of a tradable element. As described further below, the volume of a particular tradable element, such as the number of stocks traded on a securities index, typically fluctuates during the course of the trading period. Volume information thus reveals how active stocks or stock indices are during a particular trading interval. The trading interval may be an entire trading period (e.g. the time between the opening and the closing of a market on a selected trading day) or a specific portion or portions of the trading period. Volume information can be used to describe and analyze the activity of a stock or stock index either in isolation or in conjunction with other trading parameters, such as stock price. By way of illustration, FIG. 1 is a graph which illustrates the average daily cumulative volume 1 of stocks traded on a stock market (lower plot) during a six month period together with the index price 2 for such stocks (upper plot) during the same period.

In the case of many tradable elements, volume activity often follows certain predictable patterns or cycles during the course of a trading period, such as a particular trading day. For example, in financial securities markets, high volume levels are typically prevalent immediately after the opening of the market due to trades left over from the previous day and a large amount of at-market-open orders, lower volume levels occur around noon when traders typically take their lunch break, thereby lowering the number of active participants in the market, and increased volume levels once again occur toward the end of the trading day when many short-term traders and institutional investors close their positions.

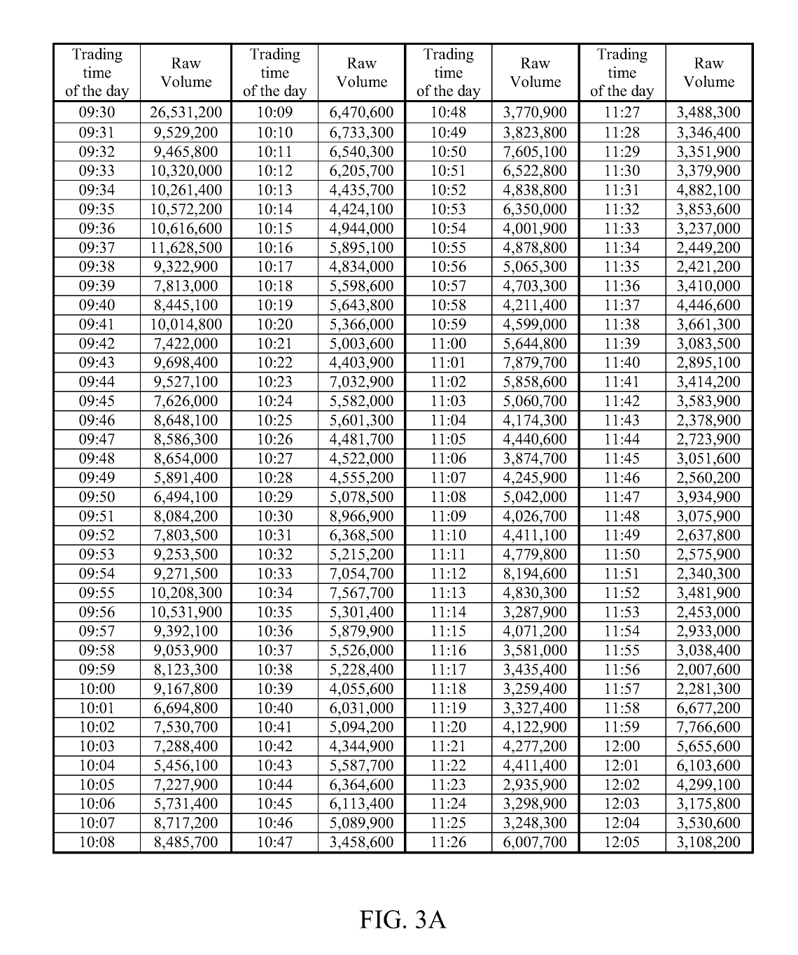

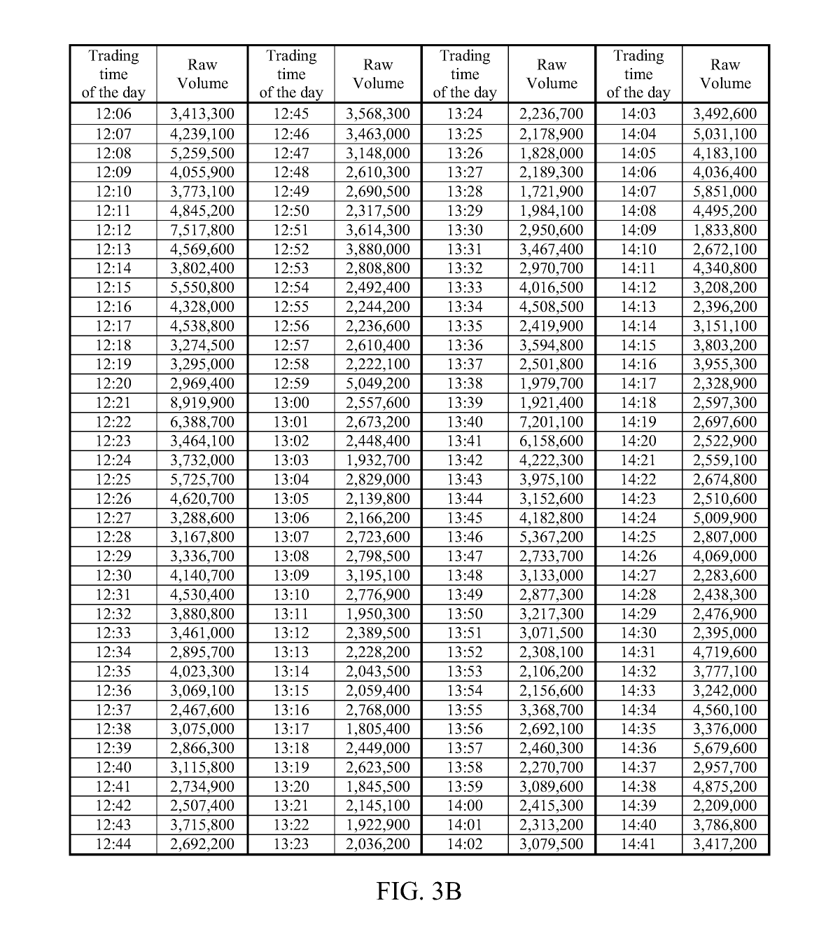

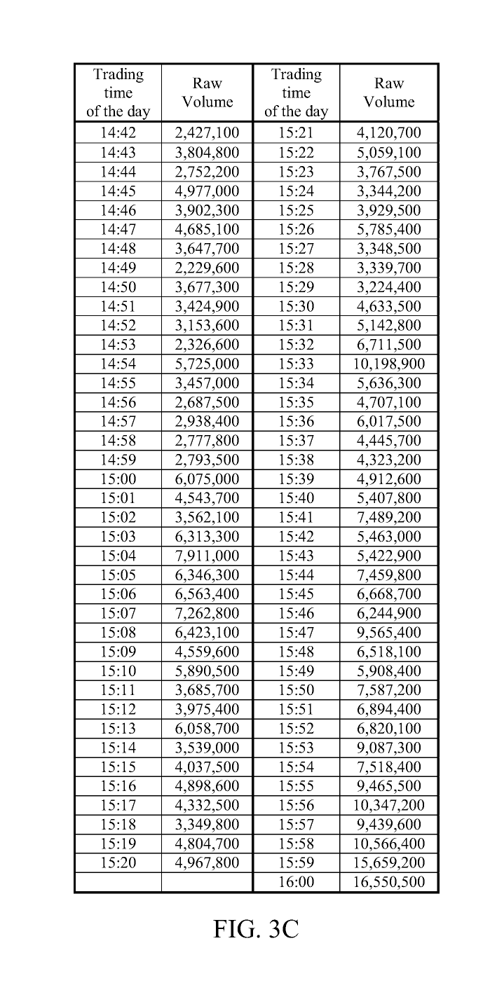

Most conventional volume indicators track cumulative volume amounts for an entire trading period, such as a day, but overlook or ignore fluctuations which occur at intervals during the trading period. As previously discussed, FIG. 1 illustrates the conventional approach, with an example that shows variations in actual volume 1 and index value or price 2 for a duration of about six months. In order to better illustrate significant volume activity, the graph in FIG. 2 shows the distribution of trades at intervals during the course of a trading period, i.e. at intra-day trading intervals. As in FIG. 1, the volume information 1 (lower plot) is presented in conjunction with price changes 2 (upper plot) during the same period for convenience, although this is not critical. In the example of FIG. 2, the average volume of the index (in this case the S&P 500) measured at one minute intervals from the opening of the market at 09:30 to the closing of the market at 16:00 and the volume information are plotted graphically. FIGS. 3A-3C taken together show a table corresponding to FIG. 2 which numerically lists the intra-day volume data for the S&P 500 over the trading day in question.

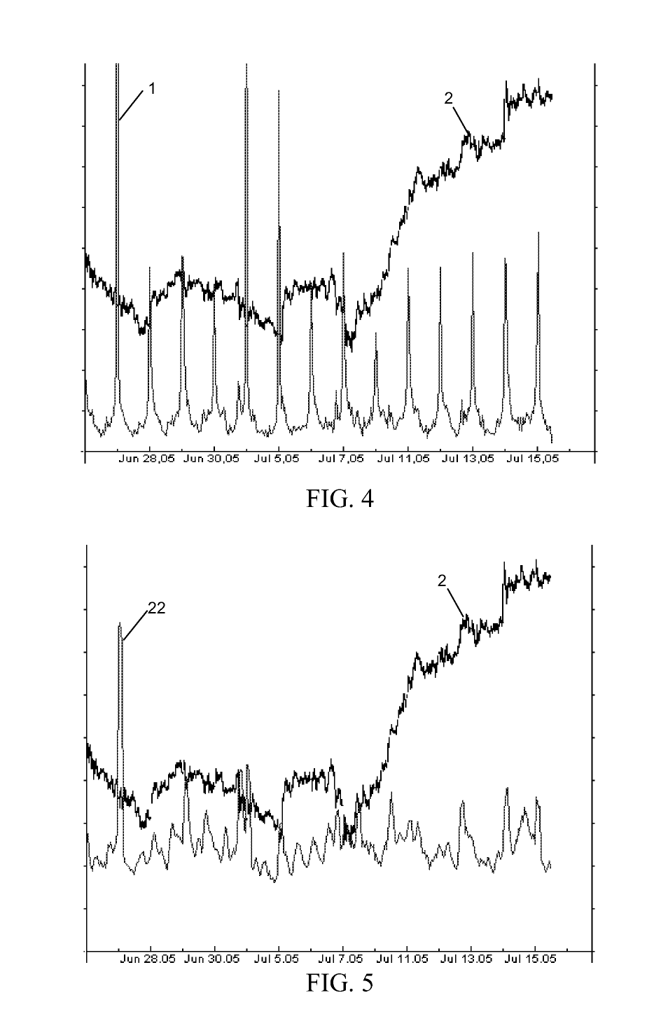

In the example of FIG. 2, the time-dependent distribution of trades when plotted resembles the shape of an inverse parabola 3. The curve of the parabola 3 thus represents the typical number of trades made at intervals during the course of the day. Accordingly, if the trading volume is below the parabola 3, the volume is considered to be below average. Likewise if the trading volume is above the parabola 3, the volume is considered to be above average. As shown in FIG. 4, which illustrates a 15 day period, this typical trade (volume) distribution 1 is repeated daily in a predictable pattern or cycle.

FIG. 5 illustrates the intra-day volume information of FIG. 4 modulated in accordance with the invention to remove the effect of cyclic variation in the distribution of trades during each trading period. By visualizing the modulated volume information 22 on an intra-day scale, abnormal increases or decreases in volume occurring at intervals during the course of a trading period can be more easily and quickly identified, and trading decisions can be made based on such volume information, as described further below.

While the means shown in FIGS. 2-4 for identifying abnormal volume activity with reference to a conventional intra-day distribution curve is helpful, there are some drawbacks to this approach. Not all markets for tradable elements exhibit a trade distribution profile resembling an inverse parabola. Moreover, even in the case of tradable elements, such as some securities indices, that do generally follow such a pattern, significant variations may occur at particular trading intervals due to various extraneous factors. For example, the distribution of trades on any given day may depend upon such factors as the time of year and holiday schedules, weather, geopolitical events or announcements, market shortages or surpluses, contractual or trading terms (e.g. expiration of options) and the like. Further, the intra-day volume distribution would also be affected if the particular day is a short trading day due to early market closures. In such cases, modulating volume information with reference to a standard trade distribution profile, such as the inverted parabola distribution of FIG. 2, can yield inaccurate information. For example, such a modulation method may obscure significant volume spikes or suggest market abnormalities where none exist.

The method and system of the present invention evaluates volume information for a tradable element modulated with reference to actual historical trading data for the tradable element rather than a standard trade distribution profile, such as an inverted parabolic curve. The term “modulated” as used herein refers to the process of modifying or altering volume information to present it in a different form. In the case of the present invention, a further aspect is to analyze the modulated volume information to more clearly and accurately reflect the actual trading activity of a tradable element at intervals during the course of a trading period. This in turn enables traders to make trading decisions based on meaningful volume information not obscured by intra-day trade distribution factors or other identifiable extraneous factors.

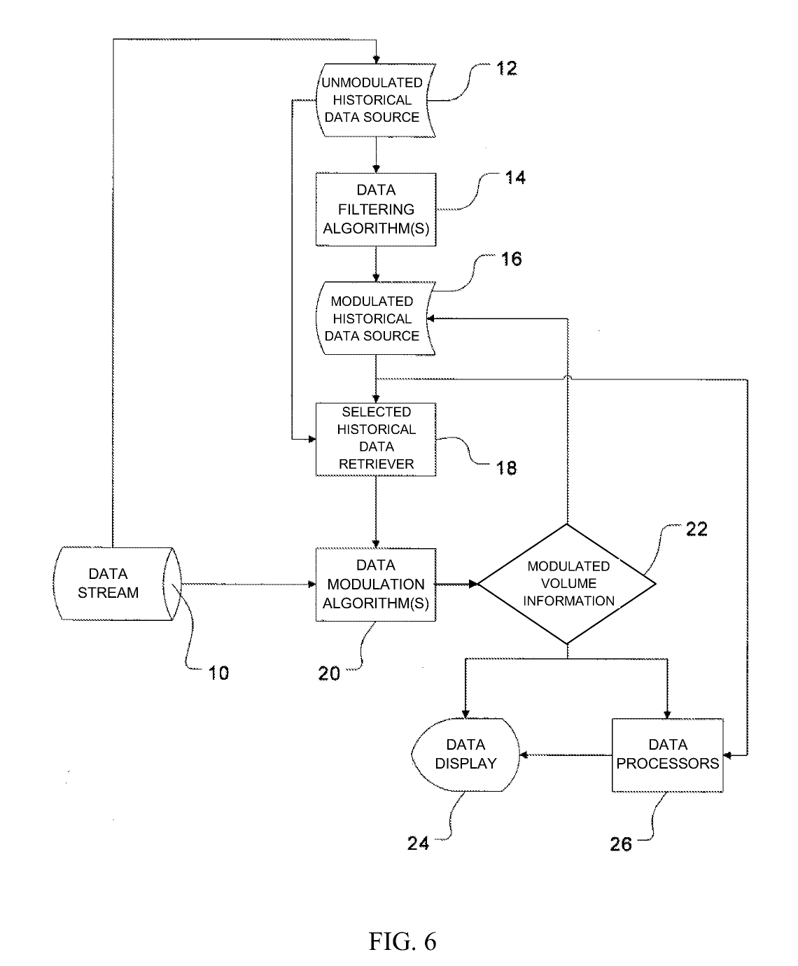

As shown in FIG. 6, in an exemplary embodiment of the invention the system includes an unmodulated historical data source 12. For example, data source 12 may constitute a database configured to store unmodulated volume information for a tradable element received from a data stream 10. Data stream 10 may constitute a real-time stream of volume information received electronically from a particular stock exchange or other data supplier. Alternatively, data stream 10 may be a source of previously stored, time-specific volume information stored in an electronic database. In one embodiment, data source 12 could store intra-day volume information received from data stream 10 for a particular securities index or other tradable element on a minute by minute basis for each of a plurality of trading days. The historical volume information may span an entire year, collection of years or other time period(s).

By way of illustration, FIGS. 3A-3C taken together show in numerical table format the type of data that may be stored in unmodulated historical data source 12. In this example, “raw”, unmodulated volume information for a particular trading index or other tradable item may be obtained from data stream 10 and stored for each minute or other desired time interval (e.g. 5 minutes, 10 minutes, 15 minutes etc.) for an entire trading day. With reference to FIG. 3A, the measured volume at 09:30 when the market opens is 26,531,200 shares, the measured volume one minute later at 09:31 is 9,529,200 shares, the measured volume a further minute later at 09:32 is 9,465,800, and so on.

As shown in FIG. 6, the unmodulated historical volume information stored in data source 12 may then optionally be processed or filtered according to one or more data filtering algorithms 14 of the system to generate modulated historical data source 16. Historical data source 16 of the system may constitute a database the same or separate from the database embodying unmodulated historical data source 12. For example, one algorithm 14 may determine which of the trading days stored in data source 12 for a selected time period exhibit a high volatility in volume according to a particular threshold. Another algorithm 14 may determine which of the trading days for the selected period stored in data source 12 exhibit a high volatility in price. Still other algorithms 14 may identify short trading days or other days or trading intervals within the selected time period which do not exhibit normal market patterns according to predetermined criteria. The filtered modulated historical data, for example excluding trading days having unusual volatility or other abnormal trading characteristics as described above, may then be stored as modulated historical data source 16 (FIG. 6). The modulated historical data comprising data source 16 would thus reflect normal trading patterns for the tradable element in question during the selected time period free of at least some filterable historical anomalies.

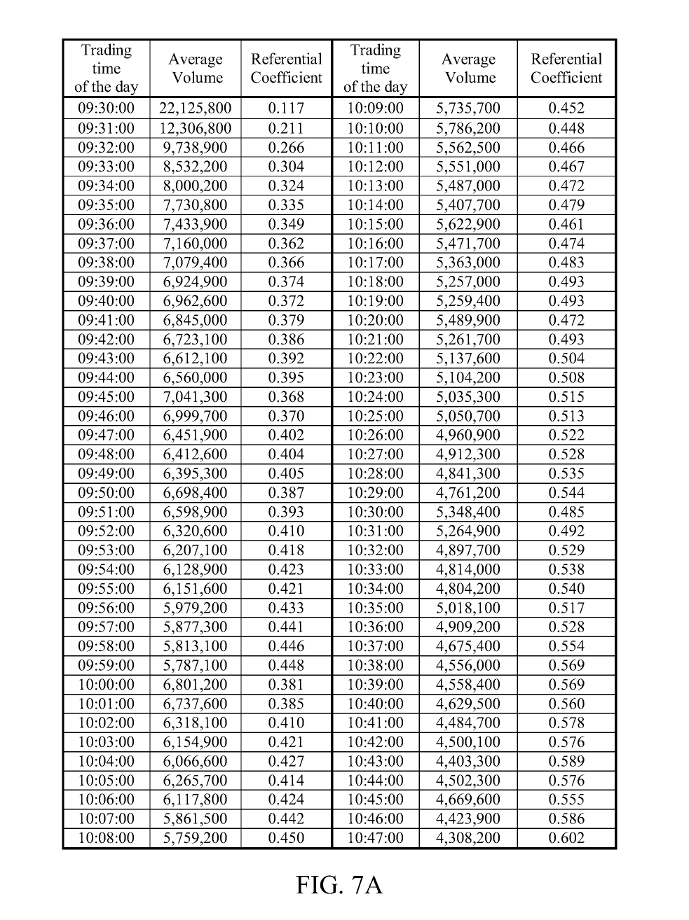

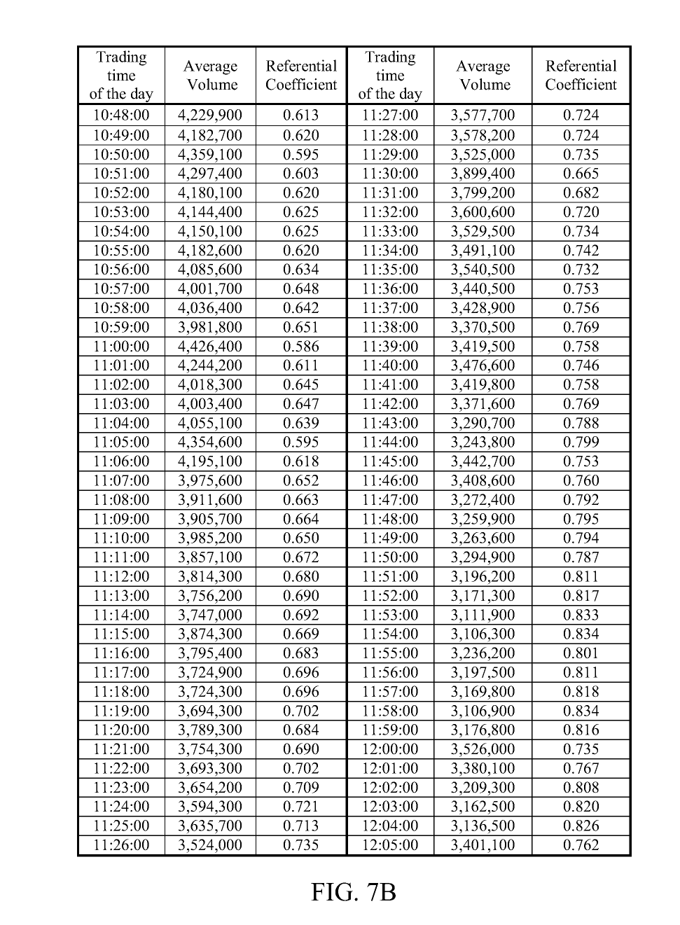

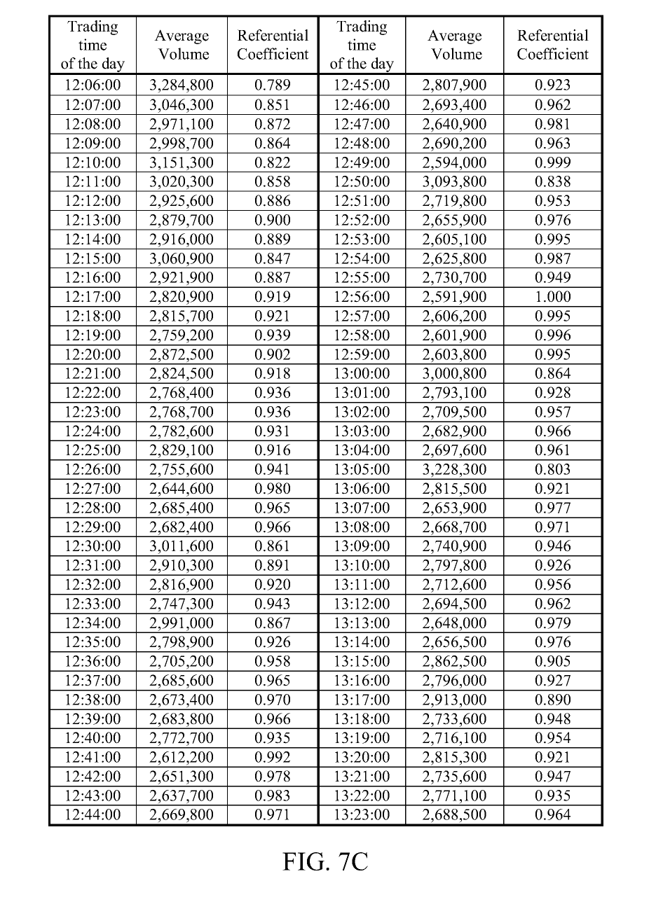

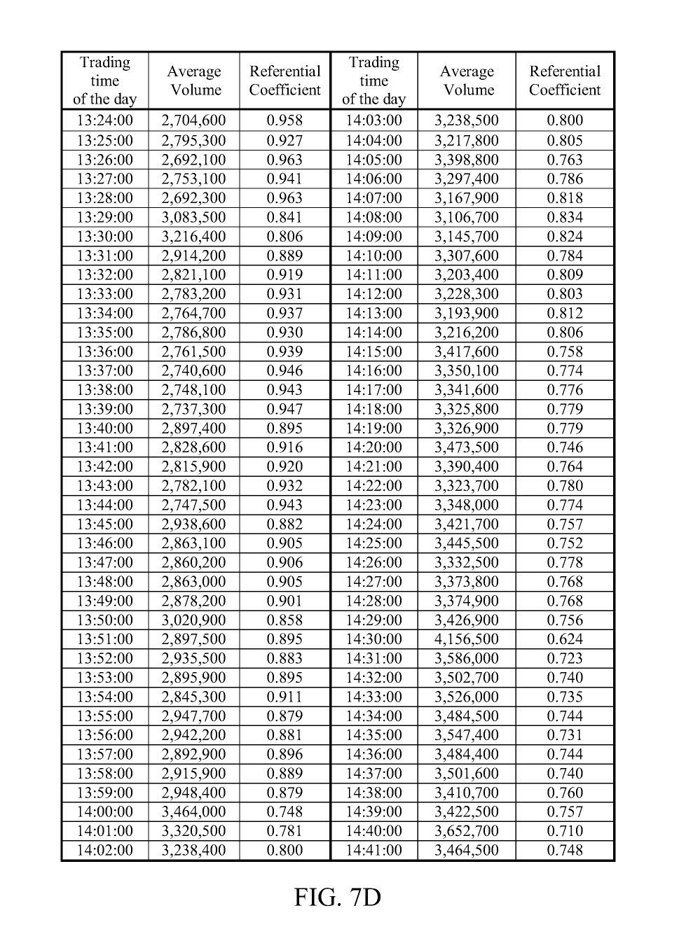

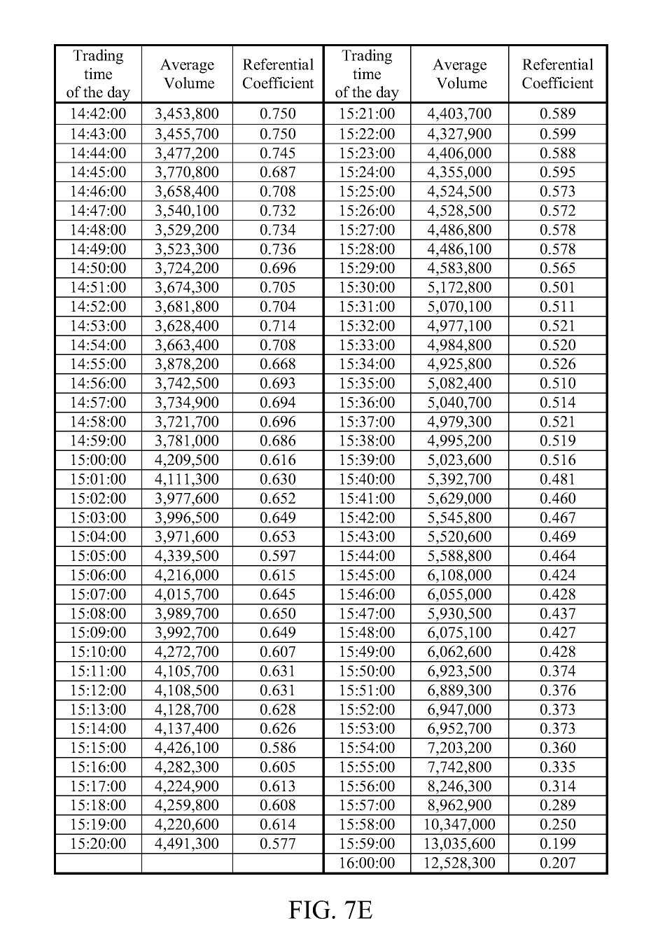

As described further below, data source 16 may also comprise volume information modulated in other manners. For example, the modulated historical data stored as data source 16 may represent statistical averages of unmodulated historical data for the selected time period. By way of illustration, FIGS. 7A-7E taken together provide a table which shows numerically the intra-day volume data for the S&P 500 averaged over multiple trading days in the calendar year 2005. In other words, the raw unmodulated intra-day volume information for the S&P 500 has been converted by a data filtering algorithm 14 into an averaged form representing historical intra-day norms for the portion of the calendar year in question. As shown in FIG. 7A, the average volume of shares traded upon the market opening at 09:30 is 22,125,800. One minute later, at 09:31:00, the average volume has declined to 12,306,800 shares. The average volume continues to decline until it reaches a nadir of 2,591,900 shares at 12:56. The average volume of shares traded then gradually increases until at market closing the average volume is 12,528,300 shares. It is important to note that while the trade distribution pattern illustrated in FIGS. 7A-7E may generally resemble the inverted parabola of FIG. 2, the modulated historical data deviates from the standard curve at intervals during the day and is a much more precise and statistically meaningful benchmark than the standard curve.

Also, as mentioned above, the parabolic curve of FIG. 2 is not the standard trade distribution profile for many securities, markets and exchanges and hence it is not a benchmark of general application. For example, in some markets trading activity can reach its highest level at mid-day rather than at market opening and closing times. A much more reliable benchmark is actual historical data for the particular market in question (whether unmodulated or modulated as described above). The present invention therefore has the advantage that it is not restricted for use in markets or exchanges having particular trading characteristics but can be adapted to reflect the particular historical intra-day trading patterns of the tradable element in question.

As shown in FIG. 6, a further feature of the system is a retriever 18 for retrieving selected historical volume information from unmodulated historical data source 12 and/or modulated historical data source 16. For example, retriever 18 may extract modulated historical volume information from data source 16 representing the average historical volume for a tradable element for a particular time period. With reference to FIG. 7A, the average historical volume for the S&P 500 at time interval 09:31 is 12,306,800 shares. The modulated historical volume retrieved by retriever 18 (i.e. 12,306,800) could then optionally be compared to an average for the entire trading period to compute a numeric coefficient corresponding to the selected time period. With reference to the example of FIG. 7C, the intra-day time with the lowest trading volume (i.e. 2,591,900 shares at 12:56) could be arbitrarily assigned the coefficient one (1). In this example the coefficient Cₜ for any other time interval t could be calculated in accordance with the following formula:

Cₜ=Vₘᵢₙ/Vₜ

where Vₘᵢₙ is the minimum average intra-day volume and Vₜ is the average volume computed for time period t. In the particular example of FIG. 7A where t=09:31, the following would apply:

C_{09:31}=2,591,900/12,306,800=0.211

Thus coefficient Cₜ is an indicator of the typical relative historical activity of the tradable element (in this case the S&P 500 index) at a particular interval in the trading period (09:31). As mentioned above, in order to better reflect typical activity, the historical data used to calculate the coefficient could first be filtered to remove trading days having unusual high volatility, short trading days and/or other trading anomalies.

As will be apparent to a person skilled in the art, coefficient Cₜ could optionally be calculated in numerous other ways. For example, coefficient Cₜ could be calculated with reference to the highest intra-day trading volume or the average intra-day trading volume rather than the lowest intra-day trading volume. Many other mathematical variations are possible. In such cases coefficient Cₜ would still function as an indicator of the typical relative historical activity of the tradable element at a particular interval in the trading period.

With reference to FIG. 6, the coefficient Cₜ could be calculated by retriever 18 based on historical data retrieved from data sources 12 and/or 16. Optionally each coefficient Cₜ corresponding to a particular time interval could be predetermined. For example, the table of FIGS. 7A-7E lists coefficients predetermined for each time interval based on averaged data. In this case, retriever 18 could simply retrieve the particular coefficient from data source 16 for the desired time interval, the coefficient being representative of historical trading activity for that time interval as described above.

As will be apparent to a person skilled in the art, many variations in the means for storing, filtering and retrieving historical trading data are possible without departing from the invention. For example, rather than calculating a coefficient based on averaged modulated volume information stored in data source 16 for a particular time interval, retriever 18 could instead be configured to retrieve unmodulated volume information from data source 12. For example, retriever 18 could be configured to select from data source 12 only historical volume information for a precise day and time interval (for example, only volume information at time interval 09:31 for Wednesdays in July). Retriever 18 could optionally be configured to process the retrieved information, such as by calculating a volume average or other indicator reflecting typical historic market activity for the selected time interval.

As shown in FIG. 6, the coefficient or other historical indicator retrieved or determined by retriever 18 may be outputted to a data converter of the system, such as data modulation algorithm(s) 20. Algorithm(s) 20 are configured to receive volume information (either current or historical) from data stream 10 and convert it into modulated volume information 22. The conversion step could be performed in real-time or after a time delay. For example, at 09:31 on a particular trading day the data converter 20 could be programmed to automatically retrieve unmodulated volume information from data stream 10 and multiply the volume amount by a numeric coefficient specific for that time interval (e.g. 0.211) provided by retriever 18, thereby determining the modulated volume information for that interval. The modulated volume information could then be displayed by a data display 24 of the system, stored as historical data in a database of the system, such as data source 16, or outputted to data processors 26 of the system. Data processors 26 may, for example, be one or more computers and/or servers, and may further take the form of one or more computer readable media carrying computer readable instructions that when processed by the one or more processors result in the performance of the processes described herein.

As mentioned above, data stream 10 may be a real-time source of data received form a data supplier such as a stock exchange or it may be a stream of previously stored data retrieved from data storage. In either case, the unmodulated volume data provided is correlated with a particular time interval within a current or historical trading period. As will be apparent to a person skilled in the art, the more recent the time interval for the unmodulated data provided by data stream 10, the more current will be the modulated volume information 22 outputted by data modulation algorithm(s) 20 (FIG. 6).

In an exemplary embodiment of the system, data display 24 may be configured for graphically displaying modulated volume information 22, for example in a chart, table or graphical form for easy reference by a user. Display 24 may be, for example, a computer monitor, a smartphone screen or an electronic tablet display, or it may be a projector that projects the display of information onto an external screen or other display surface. FIG. 8 shows one possible chart where modulated volume information 22 (lower plot) is displayed in conjunction with price information 2 (upper plot) for the corresponding time intervals. Because the volume information has been modulated to remove fluctuations attributable to typical time-dependent intra-day time distribution factors, abnormal volume spikes or dips are much easier to identify and track.

As mentioned above, once modulated volume information 22 has been determined, it can be optionally stored in modulated historical data source 16 or in a separate database (i.e. once determined, volume information 22 may be saved as historical volume information for the time interval in question). Data processors 26 may be one or more algorithms stored on the computer readable media for further processing modulated volume information 22, for example to generate trading signals or alerts when abnormal market activity is detected. Data processors 26 may also be algorithms for analyzing historical volume information in conjunction with other market information, such as price data. As will be appreciated by a person skilled in the art, many different types of technical analysis may be envisioned which could usefully employ modulated volume information 22. For example, data processors 26 may calculate and output to data display 24 (FIG. 6) moving averages of modulated volume information for selected time periods. The historical data required to calculate such moving averages could be retrieved from modulated historical data source 16 or some other source. The modulated volume moving averages may range in duration from as short as a few minutes to as long as several months or years. Other technical analysis indicators and tools which may employ modulated volume information 22 include modulated volume advance/decline indicators, volume up/down indicators and modulated volume oscillators. Further, intra-day modulated volume information may be further processed and converted to daily volume information for a particular interval, thereby showing the influence of intra-day volume fluctuations on price.

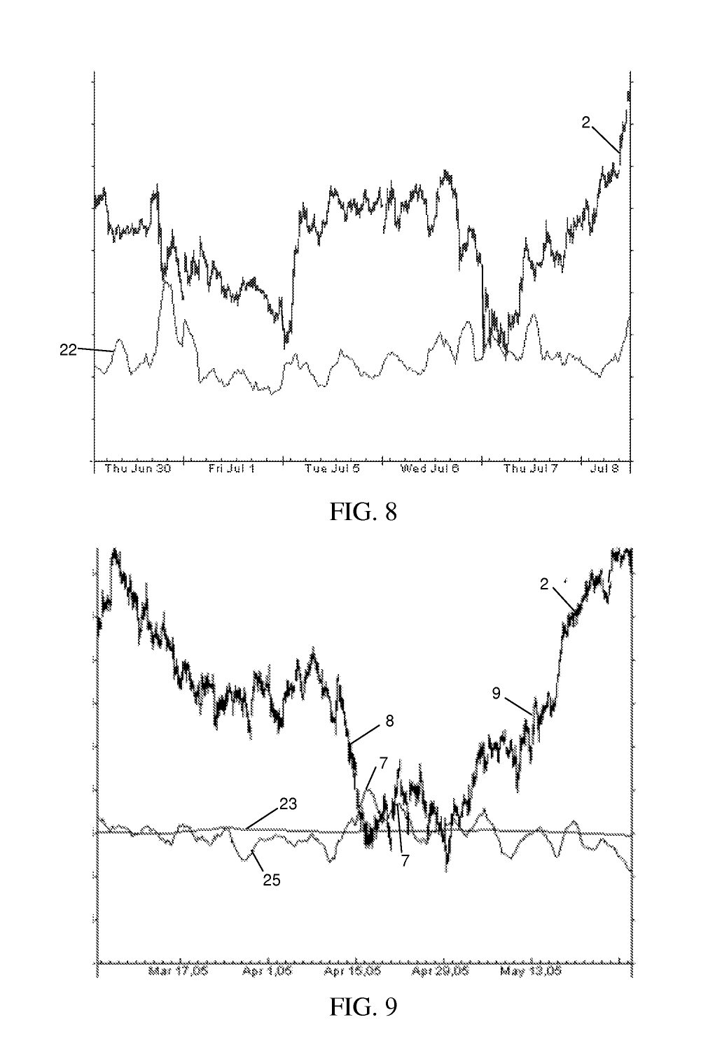

One of the premises of the present invention is that volume and market index behaviours are closely related and that trading patterns of an index may be predicted, or at least anticipated, from a proper understanding of unfolding modulated volume patterns. Volume analytics generated by processors 26 thereby provide traders with an elegant way of monitoring and analyzing the volume behaviour of a tradable element, such as a particular index or sub-index, and allow traders to heed one of the golden rules of trading, “Do not play against the market”. Index values will often (sometimes immediately, sometimes with a delay) react to volume spikes, and the greater the magnitude of the spike (or series of spikes), the stronger the ensuing reaction. As mentioned above, there are many complex reasons why volume surges may occur. FIG. 9 illustrates this feature with reference to recent historical trading data for a particular securities index, namely the S&P 500. FIG. 9 shows moving averages 23, 25 of modulated volume information 22 for an approximate three month period (March-May, 2005). As shown in the FIG. 9 chart, two abnormal volume spikes 7 occurred in late April of 2005. The relative size, number and frequency of abnormal modulated volume spikes can provide valuable information regarding likely market trends. In the FIG. 9 example, the two volume spikes correspond with a distinct trend change for the S&P 500. In particular, following the volume spikes, the market downtrend 8 in the S&P 500 reversed and switched to a steady up-trend 9 as shown in FIG. 9. A modulated volume analysis chart, such as may be generated by data processors 26 and displayed by data display 24 (FIG. 6), can provide insight why such a reversal may have occurred.

In many cases the relationship between volume spikes and index reversals applies equally well to both long-term and short-term index changes. Various technical considerations apply. As mentioned above, comparatively larger or longer modulated volume spikes are ordinarily more significant indicators of market activity than smaller spikes. The greater the magnitude and duration of a volume spike, the greater the likelihood that the supply/demand balance will be altered over the long-term. By studying the volume patterns of an entire index (i.e., a basket of many securities as opposed to just a single stock), one can see this wholesale exchange of shares occurring for entire sectors—or even at the level of the broad market. This process of transferring huge numbers of shares often precedes key market reversals (index turning points).

Caution must be exercised, however, when analyzing volume spikes over a very short time frame as their potential impacts on mid or long-term market trends can be misjudged. A noteworthy volume spike appearing on a 5 minute chart of modulated volume information may well affect an index in the short-term, but it may not necessarily have a significant impact on the prevailing long-term market trend. The present invention enables traders to analyze volume spikes in a broader market context by consulting several charts generated by the method and system of FIG. 6 having different settings. For example, historical modulated volume moving averages ranging from intra-day to 2 years could be viewed as described above to ensure that current market activity is considered fully in the context of past events. By considering only modulated volume information 22, the present invention ensures that past data is not distorted by historically normal volume fluctuations during the trading period (e.g. intra-day fluctuations).

With respect to the analysis of modulated volume, a method of positive and negative volume filtering may make use of one or more technical indicators which define whether the direction of the price is upwards or downwards. Methods disclosed herein of filtering negative and positive volume allows single price spikes to be ignored, and also allows price bounces and corrections to be ignored.

Another improvement provided by the analysis of modulated volume in the present invention is the ability to ignore volumes traded during intervals of low or no price change, or during small changes in the price moving average, otherwise known as sideways trading.

The commonly used methods of positive/negative volume filtering as described in the Background result in the processing of volumes for all trading intervals, despite the fact that there are periods of sideways trading. The commonly used methods of filtering volume define volume as negative or positive without any exception. As an example, if an index moves up by $0.01 the volume associated with the trading interval will be considered as positive. Even though the index price may generally move in a range between $7,000 and $15,000, a price change as small as $0.01 (i.e. very small in relation to the index price) would still result in a positive trading volume using already known methods. Such drawbacks would be evident in positive/negative volume filtering methods irrespective of whether the actual volume or the modulated volume were analyzed.

In contrast, one or more of the methods disclosed herein includes filtering to remove volume from consideration during sideways price trends and during small price changes. Further, it is possible to remove from the analysis the volume associated with price spikes, short-lived price corrections and upward price bounces. In this way, by using the disclosed method incorporating filtering volume, depending on the filtration settings, investors may select to analyse or view only the volumes which are associated with strong upward and/or downward price or value trends.

Level Filtering

The aim with level filtering, or straight line filtering, is to extract and display volume surges associated with strong price trends and remove volume associated with weak and sideways trends, short-lived downward corrections and short-lived upward bounces. By doing this, further analysis or display of the remaining filtered volume only is possible.

Volume surges reflect moments when large numbers of shares are changing hands between investors. In many cases such moments may lead to a shift in the supply/demand balance, i.e. the state when those who wanted to buy have already bought and those who wanted to sell have already sold. Furthermore, it makes sense to separate volume surges that may identify periods of greedy buying and/or periods of panic selling and distinguish them from the volume which is associated with normal trading.

Modulated volume may be calculated and displayed to allow abnormal volume activity, or volume surges, to be seen relative to normal activity. This can be seen in FIG. 5 and FIG. 8. However, further steps may be taken to substantially remove the normal volume activity such that essentially only abnormal volume is displayed, allowing for more rapid interpretation by the viewer.

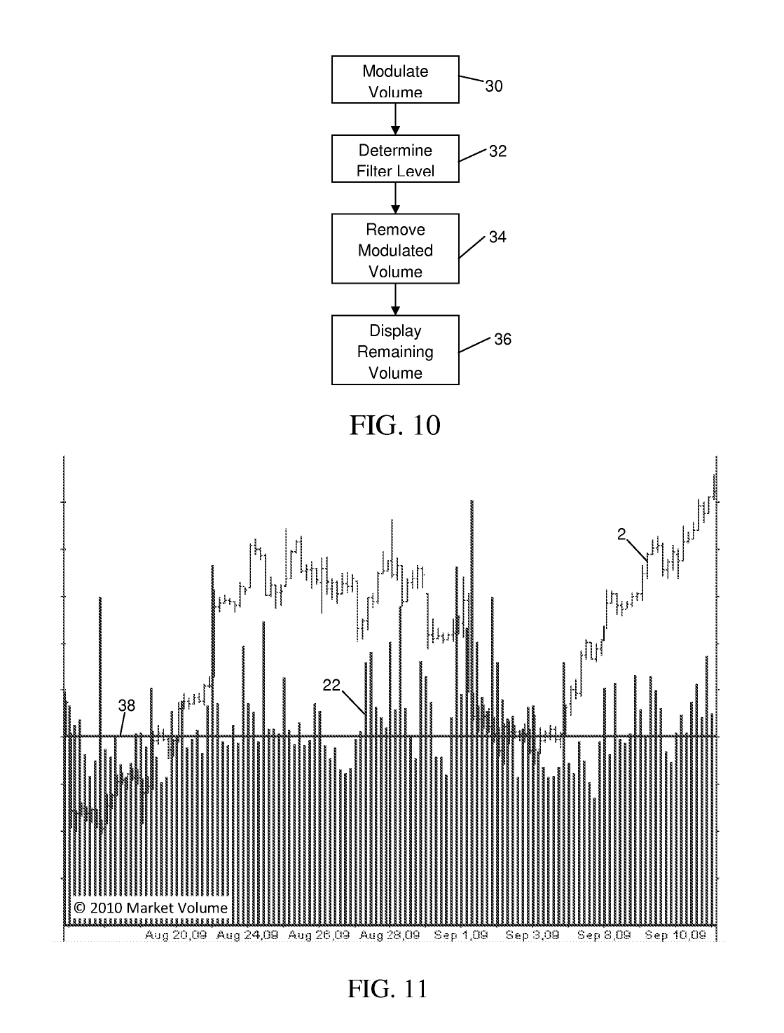

An exemplary embodiment of a processor-implemented method is shown in FIG. 10, which may be one of the algorithms performed by the one or more data processors 26 of the system of FIG. 6. The overall principle is to remove volume that does not fit selected criteria from the display and from further analysis. A filter level may be the criterion used to filter the modulated volume. In step 30, the volume information for a stock or index is first modulated according to a method described above. In step 32, the filter level is determined or has previously been determined. In one exemplary embodiment, the filter level may in the form of a filter line 38, shown in FIG. 11, used by the system in step 34 to remove portions of the modulated volume 22 that may be unwanted. The filter line 38 may be a straight line that represents a specific modulated volume level, an average modulated volume level or it could be a moving average.

Referring back to FIG. 10, the modulated volume is reduced in step 34 by the amount of the modulated volume that is below the filter level, or filter line 38. If the result would be less than zero, the result is set to zero. An alternate step to this would be to simply remove the modulated volume data for those trading intervals that have modulated volume data below the filter line and leave the values of the other modulated volumes intact.

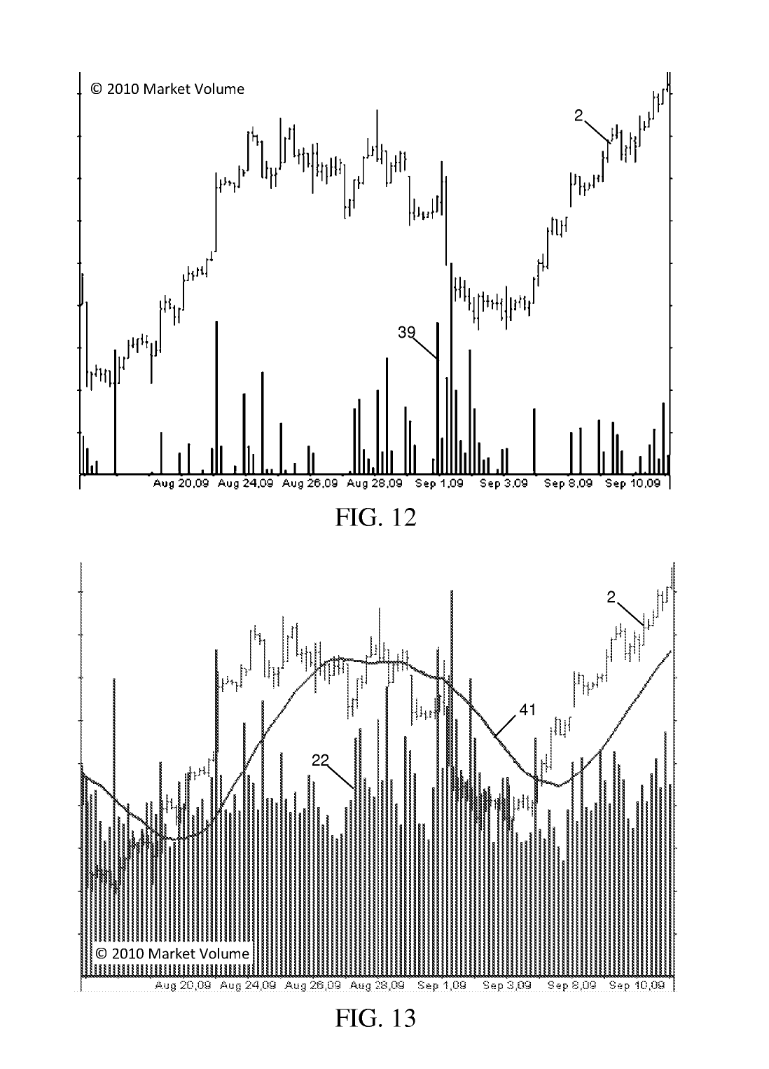

Once the modulated volume below the filter line 38 has been removed, in step 36 the data processor 26 displays the remaining modulated volume information on the data display of the system of FIG. 6. FIG. 12 shows an example of a displayed graph that has had modulated volume data below the filter line removed. The remaining modulated volume information 39 that is displayed is that which was above the filter line 38 of FIG. 11.

While the filtered, or remaining modulated volume data 39 is displayed as is in FIG. 12, further treatment of the data may be performed by the data processor 26, such as calculating and displaying a moving average.

Filtering Using a Price Moving Average (PMA)

In another exemplary embodiment, the filter level may in the form of a price moving average. The price moving average may, for example, be for the price of a stock or it may be for a value of an index or any other tradable element. FIG. 13 is a graph showing values of a stock market index and modulated volume for an eighteen day period, with a price moving average of the values of the stock index.

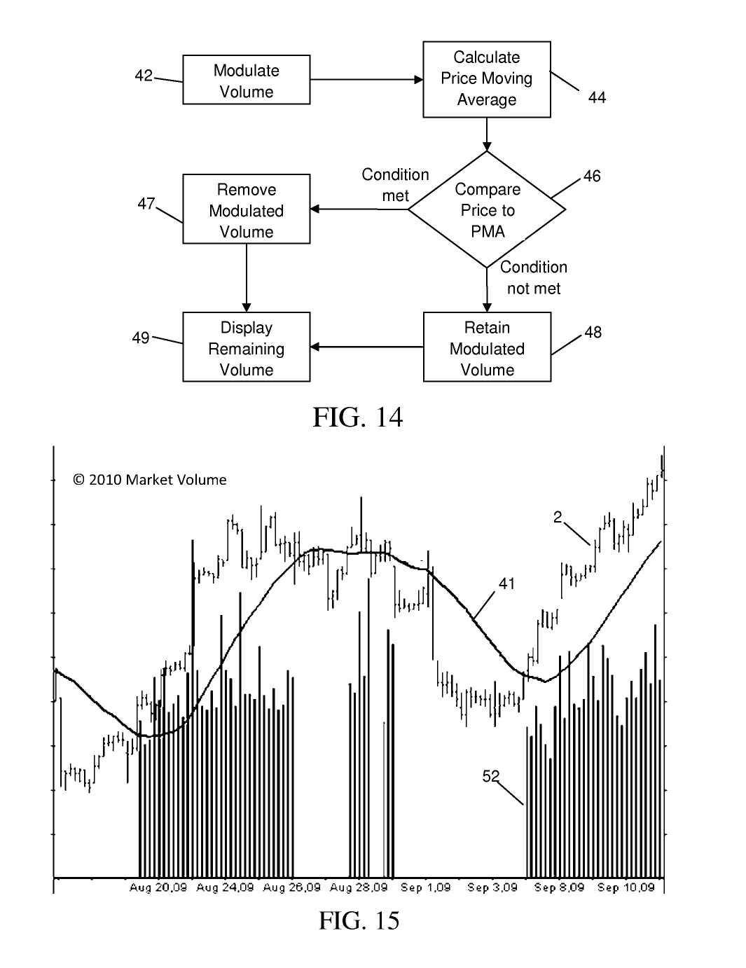

Referring to FIG. 14, another exemplary embodiment of the processor-implemented method is shown that analyzes and filters modulated volume information with respect to a price moving average and displays the result. In step 42, the modulated volume is calculated as described before. The price moving average is calculated in step 44. For each trading interval considered, the current price is compared in step 46 to the price moving average. For example, the comparison may involve a subtraction of the price moving average from the price, which would result in a positive, zero or negative value. If the result is positive, then the price is above the price moving average. If the result is negative, the price is below the price moving average. The comparison may determine whether the current price is above or below the price moving average, and filter the modulated volume data for the corresponding interval according to such a condition. In another embodiment, the condition may be whether the price is within or outside a certain range relative to the PMA, and the system will filter the modulated volume data for the corresponding interval accordingly. By filtering the modulated volume accordingly, it may be removed 47 or retained 48 depending on whether the condition is met or not in the particular embodiment selected. Following the removal or retaining of the modulated volume for a trading interval, the resulting value of the modulated volume is displayed.

There are several examples shown in FIGS. 15-17 of how the price moving average as the filter level may be used.

One example is shown in FIG. 15 where the modulated volume has been removed for periods where the price 2 is below the price moving average. The remaining modulated volume 52 that is displayed is that for trading intervals where the price 2 is above the PMA 41. In cases where the price equals the PMA, the modulated volume may either be retained or removed depending on the embodiment selected.

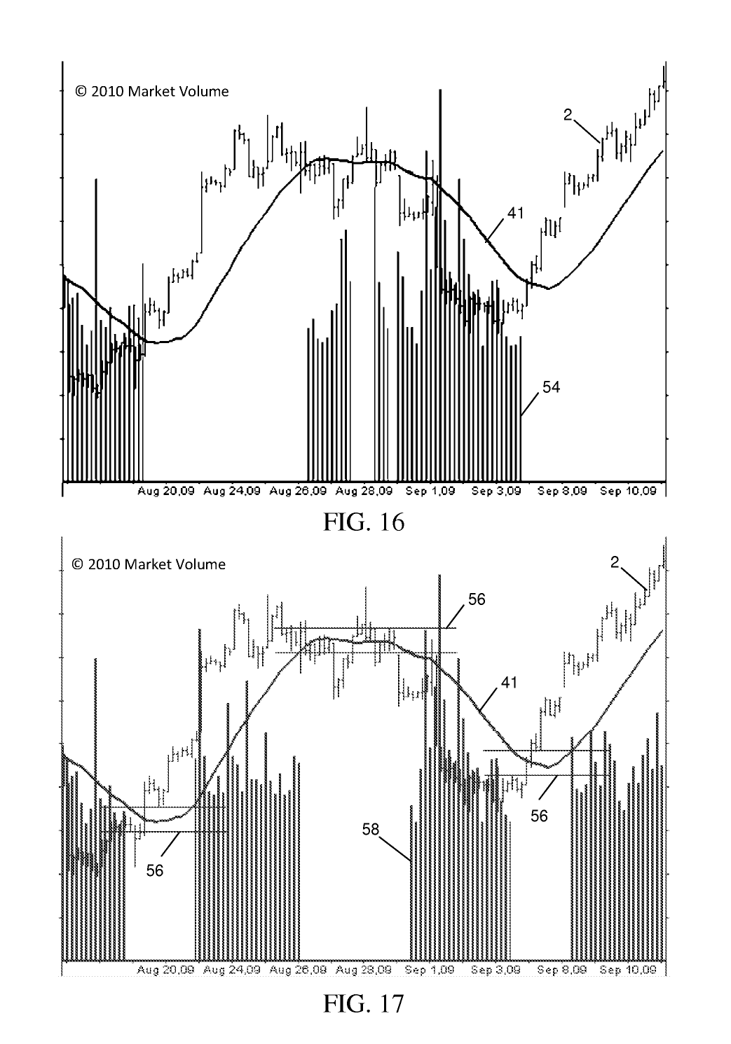

Another example is shown in FIG. 16 where the modulated volume has been removed for periods where the value of the index is above the price moving average. The remaining modulated volume 54 that is displayed is that for which the price 2 is below the PMA 41. In cases where the price equals the PMA, the modulated volume may either be retained or removed depending on the embodiment selected.

Yet another example is shown in FIG. 17 where the modulated volume has been removed for periods where the value PMA is relatively flat. These ranges of values of the PMA are indicated by the horizontal lines 56. The times when the PMA is relatively flat may be determined by calculating the derivative of the PMA, and determining that the PMA is flat when the magnitude of the derivative is below a predetermined value. The remaining modulated volume 58 that is displayed is that for trading intervals where the price is changing significantly, or more accurately, when the PMA is changing significantly. Further treatment of the results may be possible before display. For example, where the PMA is increasing, the modulated volume may be coloured green, to indicate positive or bullish volume. Conversely, where the PMA is decreasing, the modulated volume may be coloured red to indicate negative or bearish volume. Again, a moving average of the retained modulated volume data may be calculated by the processor before displaying. In another embodiment the negative modulated volume that is retained may be multiplied by −1 before display.

In an alternate embodiment, the computer-implemented method shown in the flowchart of FIG. 14 may use a fast price moving average (FPMA) instead of the current price for the calculations. In this case, the PMA will be averaged over a longer timescale than the fast price moving average. The use of the FPMA may be used instead of the current price for the embodiments shown in FIGS. 15-17.

The system of FIG. 6 may also be configured to use a combination of volume filtering methods to achieve a desired result. For example, the modulated volume may both be straight line filtered and filtered using a PMA.

In order to display the filtered modulated volume is a fashion that is comparable to other technical indicators, the system may recalculate modulated and/or filtered modulated volume data into values that oscillate in a range from 0-100%. There are many ways in which this may be achieved. One example is where the system selects a historical period that includes analyzed trading interval and that is longer than the analyzed trading interval. The system then determines the highest filtered modulated volume within this historical period and assigns to this volume the value of 100%. The system then recalculates the other filtered modulated volume values in the analyzed period as percentages corresponding to their value divided by the value of the highest filtered modulated volume. If the currently filtered volume would have a value of greater than 100%, then it alone can be adjusted to be equal to 100% or the set of values already calculated can all be readjusted such that the percentage values of the modulated volumes are in proportion to the modulated volumes.

Although the present invention has been illustrated principally in relation to financial market indices, it has wide application in respect of other tradable elements which fluctuate in volume during the course of trading periods, especially tradable elements which repeatedly fluctuate according to predictable patterns. For example, the invention could be applied to single securities rather than groups or indices of securities. The invention could also be applied to measurable quantities of other volume-related items, such as the number of contracts (e.g. options), ticks and open interest at intervals within a trading period. The invention provides a means for removing the effect of historically normal volume fluctuations during a trading period so that more significant abnormal market activity can be more easily visualized and acted upon in a timely manner, if desired.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A processor-implemented method for evaluating modulated volume information for a tradable element, comprising:
(a) determining by a data processor modulated volume information for a plurality of time intervals in a selected trading period so as to provide abnormal volume variation information for said tradable element during said trading period;
(b) filtering by the data processor said modulated volume information to remove a first portion thereof and leave a filtered second portion thereof in respective relationships to a criterion comprised by a filter level; and
(c) displaying on a data display said filtered second portion of said modulated volume information.

2. The method as defined in claim 1 wherein said relationship of first portion of said modulated volume information to said criterion is below said filter level.

3. The method as defined in claim 1 wherein said relationship of said second portion of said modulated volume information to said criterion is above said filter level.

4. The method as defined in claim 1 wherein said filter level is a filter line.

5. The method as defined in claim 4 wherein said filter line is a substantially straight line.

6. The method as defined in claim 4 wherein said relationship of first portion of said modulated volume information to said criterion is below said filter line.

7. The method as defined in claim 4 wherein said relationship of said second portion of said modulated volume information to said criterion is above said filter line.

8. The method as defined in claim 1 wherein said filter level is a moving average of values of said tradable element.

9. The method as defined in claim 8 wherein said relationship of first portion of said modulated volume information to said criterion is in one or more time intervals for which said value or values are below said moving average.

10. The method as defined in claim 8 wherein said relationship of said second portion of said modulated volume information to said criterion is in one or more time intervals for which said value or values are above said moving average.

11. A processor-implemented method for evaluating modulated volume information for a tradable element, comprising:
(a) determining by a data processor modulated volume information for a plurality of time intervals in a selected trading period providing abnormal volume variation information for said tradable element during said selected trading period;
(b) calculating by said data processor a price moving average for said time intervals; and
(c) filtering by the data processor said modulated volume information to remove a first portion thereof and leave a filtered second portion thereof in respective relationships to said price moving average.

12. The method as defined in claim 11 wherein said relationship of first portion of said modulated volume information to said price moving average is a price below said price moving average.

13. The method as defined in claim 11 wherein said relationship of said first portion of said modulated volume information to said price moving average is a price above said price moving average.

14. The method as defined in claim 11 wherein said relationship of said first portion of said modulated volume information to said price moving average is a price that causes less than a predetermined amount of change in the price moving average.

15. A system for evaluating modulated volume information for a tradable element, comprising:
a data processor;
a data display in communication with the data processor; and
a computer readable medium carrying instructions for processing by said data processor;
the system being configured to:
(a) determine by said data processor modulated volume information for a plurality of time intervals in a trading period so as to provide abnormal volume variation information for said tradable element during said trading period;
(b) filter by said data processor said modulated volume information to remove a first portion thereof and leave a filtered second portion thereof in respective relationships to a criterion comprised by a filter level; and
(c) display on said data display said filtered second portion of said modulated volume information.

16. The system as defined in claim 15 wherein said relationship of first portion of said modulated volume information to said criterion is below said filter level and said relationship of said second portion of said modulated volume information to said criterion is above said filter level.

17. The system as defined in claim 15 wherein said filter level is a substantially straight line.

18. The system as defined in claim 17 wherein said relationship of first portion of said modulated volume information to said criterion is below said filter line and said relationship of said second portion of said modulated volume information to said criterion is above said filter line.

19. The system as defined in claim 15 wherein said filter level is a price moving average of values of said tradable element.

20. The system as defined in claim 19 wherein said relationship of first portion of said modulated volume information to said price moving average is:
a price below said price moving average;
a price above said price moving average; or
a price that causes less than, or less than or equal to, a predetermined amount of change in the price moving average.
